(19) United States
(12) Patent Application Publication
(10) Pub. No.: US 2008/0183932 A1
(43) Pub. Date: Jul. 31, 2008

(54) Talking webcam

(76) Inventor: Wei Hsu, Taipei County (TW)

Correspondence Address: Wei Hsu, P.O. Box 44 - 2049, Taipei, 10668, omitted

(21) Appl. No.: 11/698,217

(22) Filed: Jan. 26, 2007

(51) Int. Cl. G06F 13/00

(52) U.S. Cl. 710/300

(57) ABSTRACT

The invention relates to a talking webcam mainly composed of a camera and a network phone. The network phone includes a USB hub integrated circuit, a USB network phone integrated circuit, an audio amplifier circuit and an echo killer in conjunction with a key set, an earphone jack, a speaker, a microphone jack, a microphone disposed on an exterior. The camera includes a USB video sensor integrated circuit, and an optical lens disposed on the exterior. Thus, the talking webcam with the video and audio functions may be obtained.

### BACKGROUND OF THE INVENTION

(1) Field of the Invention

The invention relates to an improvement of a structure of a webcam, and more particularly to a novel and utility talking webcam.

(2) Description of the Prior Art

At present, the Internet service providers have enhanced and improved the video transmission quality, and various IC foundries have developed USB2.0 network photographing chips. Thus, after the video signal transmission bandwidth and the frame reading speed are greatly enhanced, the webcam is getting more and more popularized. In the future, the network photographing may possibly become a standard computer peripheral, such as a mouse or a keyboard. The long-distance video transmission is free from the serious defects, such as delay, pause and halt, and the frame quality also becomes clearer so that the remote friends or customers in meeting may have the real live feelings. Thanks to the progresses in the network technology and the electronic technology, the pre-discussion and the stage result consideration for the normal work may be made through the video-audio conference to exchange the opinions, to explanation the thoughts, to watch the real object, or to make a comparison between various graphs. Thus, the traffic cost and the travelling fatigue may be greatly reduced, and it is advantageous to the increase of the efficiency.

When the current webcam is used, the user in front of a photographing lens talks to the other user. If the user wears an earphone and talks to an upright microphone or wears an earphone-microphone set, he or she may feel that himself or herself is not really meeting with the other user, and the redundancy kits may shield a portion of the face. Thus, the user may feel that he or she is talking to an announce or an operator, and thus feel unkind and have the distant feeling. In particular, when the earphone is worn for a long time, the professional also warns that the audition may deteriorate rapidly so that the safety of the user is influenced. Furthermore, the user may be restricted by the lines of the earphone, the microphone or the earphone-microphone set and thus feel uncomfortable.

The present inventor has felt that the function of the conventional webcam structure is not perfect and has spent a lot of time to find the solution by way of studying and testing so as to provide an utility talking webcam. The talking webcam is made by adding audio output and input devices to the small camera structure, and the output volume of the audio is large enough to let the user hear the audio clearly without interfering the volume output of the microphone while satisfying the requirements of the speaker and the circuit.

### SUMMARY OF THE INVENTION

It is therefore an object of the invention to provide a talking webcam capable of generating audio with the sufficient volume so that the network video participants can clearly hear the talking audio contents without wearing the earphone or microphone and clearly see the ambient environment of the other side. Thus, the free talking effectiveness can be achieved.

To achieve the above-identified object, the invention adds a network phone to a camera. The network phone includes a USB hub integrated circuit, a USB network phone integrated circuit, an audio amplifier circuit and an echo killer in conjunction with a key set, an earphone jack, a speaker, a microphone jack and a microphone. The camera includes a USB video sensor integrated circuit connected to an optical lens disposed on an exterior. Thus, the talking webcam with the video and audio functions may be obtained so that the high convenience and the high utility in use may be achieved, and the additional value thereof may be enhanced.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a circuit block diagram showing a talking webcam according to a preferred embodiment of the invention.

FIG. 2 shows an exterior structure of the talking webcam according to the preferred embodiment of the invention.

FIG. 3 is an exploded view showing a structure of the talking webcam according to the preferred embodiment of the invention.

FIG. 4 is a schematic illustration showing a first operation of the talking webcam according to the preferred embodiment of the invention.

FIG. 5 is a schematic illustration showing a second operation of the talking webcam according to the preferred embodiment of the invention.

### DETAILED DESCRIPTION OF THE PREFERRED EMBODIMENTS

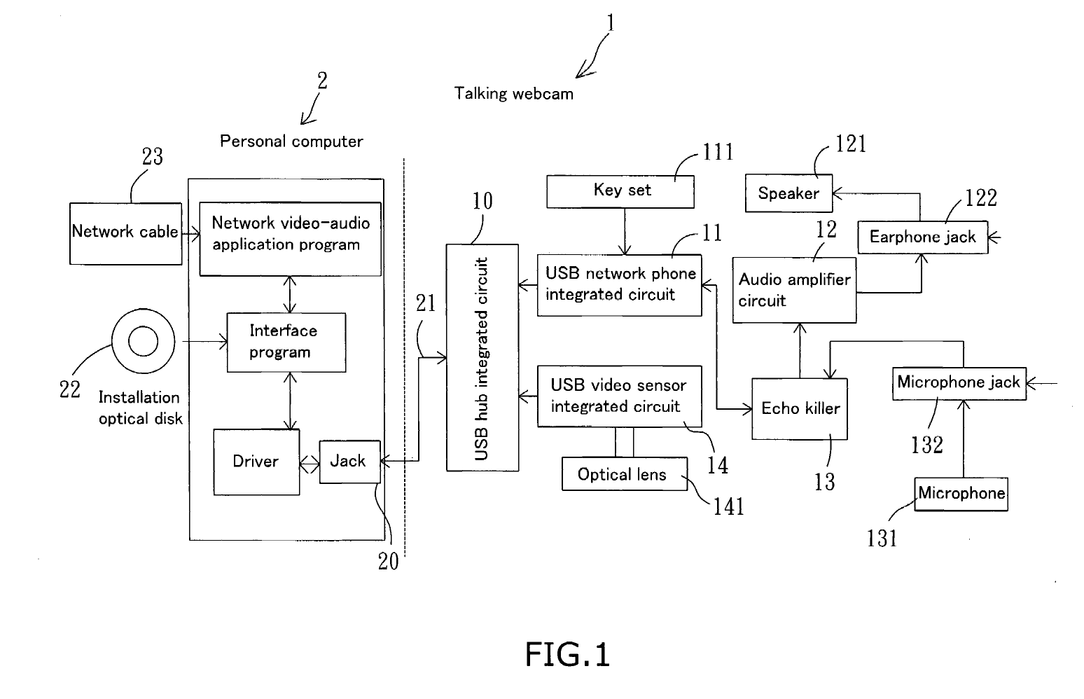

FIG. 1 is a circuit block diagram showing a talking webcam according to a preferred embodiment of the invention. As shown in FIG. 1, a talking webcam 1 is composed of a camera and a network phone. The network phone includes a USB hub integrated circuit 10, a USB network phone integrated circuit 11, an audio amplifier circuit 12, and an echo killer 13.

The USB hub integrated circuit 10 integrates different kinds of video and audio together and is coupled to a cable 21 having a USB plug 211 to be connected to a personal computer 2.

The USB network phone integrated circuit 11 processes a digital signal, which is transmitted to the USB hub integrated circuit 10 through the cable 21, and decodes the digital signal into an audio signal that can be heard by the human ear. A key set 111 connected to the USB network phone integrated circuit 11 is disposed on the exterior of the talking webcam.

The audio amplifier circuit 12 amplifies the power of the audio signal to push a speaker 121 disposed on the exterior of the talking webcam so that the speaker 121 generates the audio of the sufficient volume that can be heard by the user. An earphone jack 122 is also disposed on the exterior of the talking webcam and connected to the audio amplifier circuit 12. An external earphone can be connected to the earphone jack 122 so that the user may use the external earphone in order to prevent others from being interfered and keep the privacy on receiving the talking contents.

The echo killer 13 kills the howling sound generated by the feedback audio signal and is connected to a microphone 131, which is disposed on the exterior of the talking webcam, receives the user's audio signal and sends a weak audio voltage to the audio amplifier circuit 12 and the USB network phone integrated circuit 11. The echo killer 13 is also connected to a microphone jack 132 to which an external microphone may be connected in order to prevent others from being interfered and keep the privacy on receiving the talking contents.

The camera includes a USB video sensor integrated circuit 14 composed of an upper video sensing unit and a lower video dedicated integrated circuit of a processing circuit structure. The video sensing unit is connected to an optical lens 141 disposed on the exterior of the talking webcam, and senses the light with various colors and brightnesses through the optical lens 141 to generate different signals. These signals are then analyzed by the video dedicated integrated circuit so that a data packet satisfying the USB transmission specification is generated and thus inputted to the USB hub integrated circuit 10 for further processing.

In addition, the talking webcam of the invention has to be used in conjunction with the personal computer 2, which has a USB jack 20 connected to the cable 21 of the talking webcam 1, and attachments including an installation optical disk 22 for storing an application program to be connected to a network phone driver so that the talking webcam 1 can be connected to the Internet through the network cable 23.

The operation principle will be described in the following. Because the video and the audio pertain to different kinds, the USB hub integrated circuit 10 is adopted to integrate the video and the audio together. Also, the USB network phone integrated circuit 11 processes the digital signal, which is transmitted to the USB hub integrated circuit 10 through the cable 21, and decodes the digital signal into the audio that can be heard by the human ear. The audio amplifier circuit 12 amplifies the power of the audio to push the speaker 121 to generate the audio with the sufficient volume that can be heard by the user, and also amplifies the weak audio voltage transmitted through the microphone 131 into the amplified voltage. The amplified voltage is then converted into a data packet satisfying the USB specification. Th data packet is transmitted to the personal computer 2 through the USB hub integrated circuit 10 and the cable 21 and then to a remote end through the network. Meanwhile, the USB video sensor integrated circuit 14 receives different signals generated by sensing the light with various colors and brightnesses through the optical lens 141. The processing circuit analyzes these signals into the data packet satisfying the USB transmission specification. Thus, the data packet is transmitted to the USB hub integrated circuit 10, transmitted to the personal computer 2 through the cable 21, and then transmitted to the destination through the network. In use, the key set 111 disposed on the surface of the network phone B may be used to control and adjust the audio volume, to answer the phone or to hang up the phone. The external earphone and the external microphone may be respectively connected to the earphone jack 122 and the microphone jack 132 in order to prevent others from being interfered and keep the privacy on receiving the talking contents.

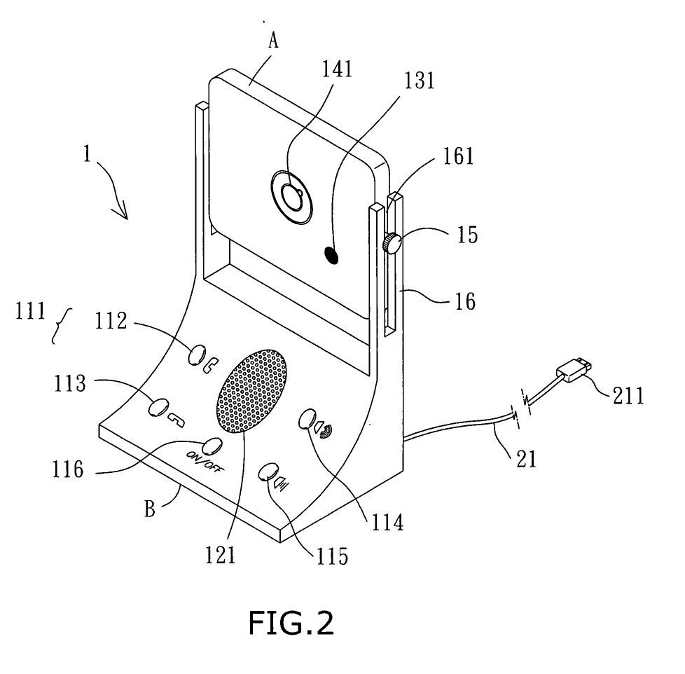

As shown in FIG. 2, the exterior structure of the talking webcam 1 includes the upper half structure of the adjustable camera A and the lower half structure of the network phone B, and the cable 21 having the USB plug 211 to be connected to the personal computer 2 is extended from the rear portion of the body.

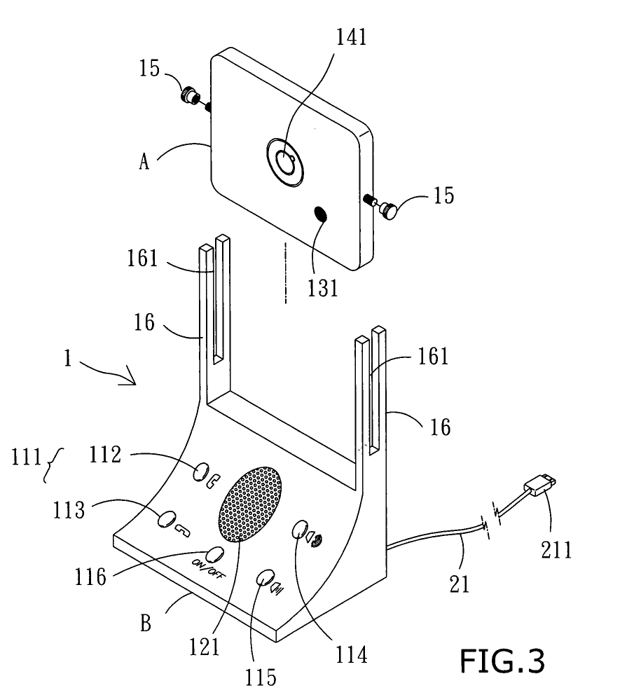

FIG. 3 is an exploded view showing a structure of the talking webcam 1 according to the preferred embodiment of the invention. Opposite knobs 15 are pivotally mounted on two sides of the adjustable camera A to combine with extension arms 16, which are formed with slots 161 and disposed on two sides of the network phone B. Thus, the adjustable camera A can be freely adjusted. The optical lens 141 and the microphone 131 are embedded into the surface of the adjustable camera A. The speaker 121 is disposed at a middle of the front surface of the network phone B, and the key set 111 is disposed around the speaker 121. The key set 111 includes an answer button 112, a hang-up button 113, a volume-up control 114, a volume-down control 115 and a switch control 116. Also, the earphone jack 122 and the microphone jack 132 (not shown) are disposed on a backside of the talking webcam 1.

During the practical installation, the installation optical disk 22 is put into the personal computer 2 so that the application program for network video-audio transmission is installed, and the video processing program built in the personal computer 2 and the USB interface circuit of the camera of the personal computer 2 are connected together to enable the supporting function. After the installation is finished, the talking webcam 1 inserted into the USB jack 20 can be recognized. At this time, the talking webcam 1 is connected to the USB jack 20 of the personal computer 2 through the USB plug 211 of the cable 21. Then, the personal computer 2 recognizes the function of the talking webcam 1, and automatically loads the required built-in driver to drive the chip in the camera to work normally.

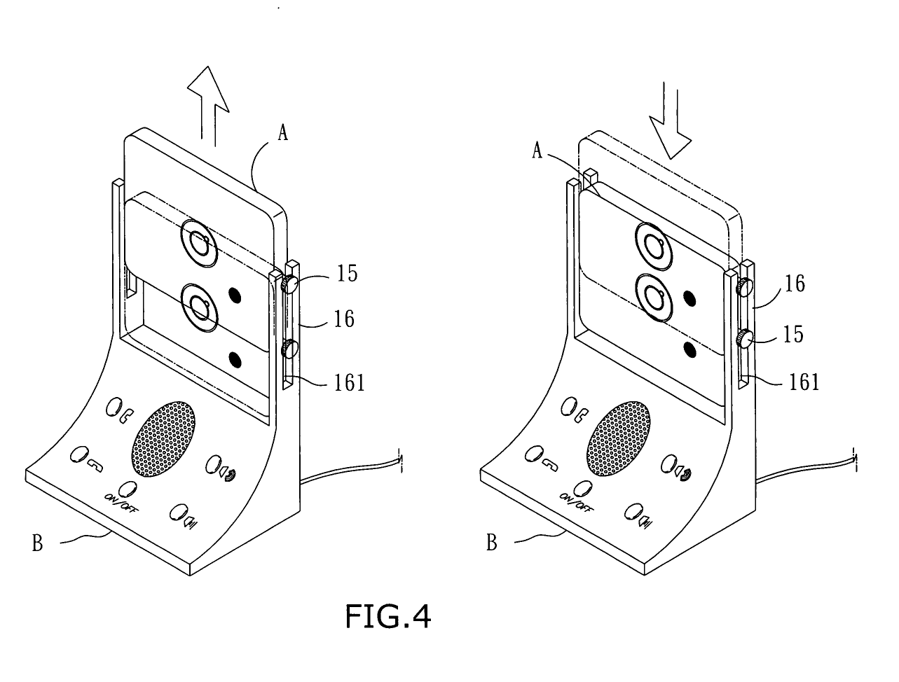

FIG. 4 is a schematic illustration showing a first operation of the talking webcam 1 according to the preferred embodiment of the invention. As shown in FIG. 4, the adjustable camera A may be adjusted to slide in the slots 161 of the extension arms 16 through the knobs 15 so that the camera A may be moved vertically.

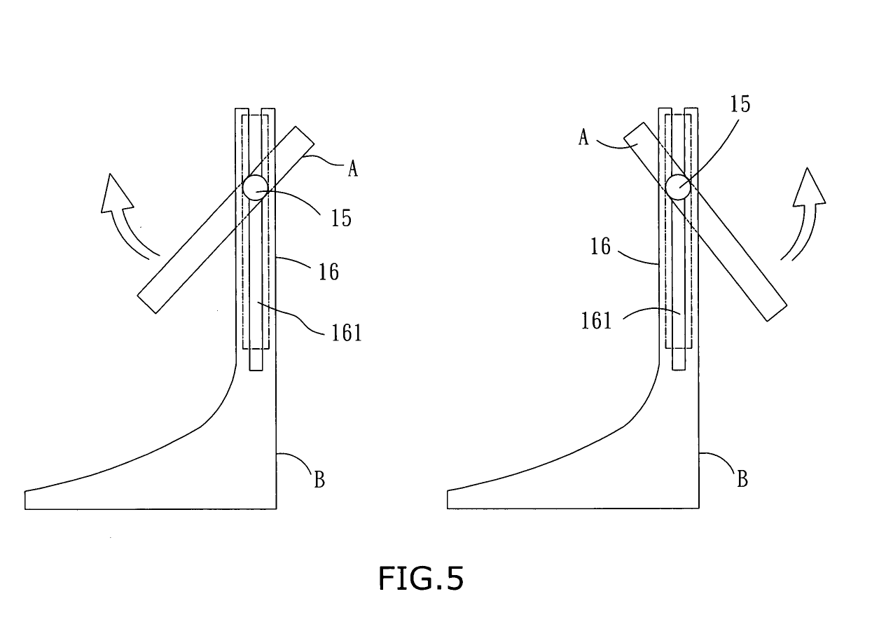

FIG. 5 is a schematic illustration showing a second operation of the talking webcam 1 according to the preferred embodiment of the invention. As shown in FIG. 5, the adjustable camera A may also be rotated by controlling the knobs 15 so that the angle suitable for the user may be adjusted.

In summary, the talking webcam of the invention integrates the video and the audio together on the webcam structure, the convenience and the utility of the webcam in use may be greatly enhanced so that the extremely high industrial value can be achieved.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A talking webcam, comprising:
a network phone, which comprises:
a USB hub integrated circuit for integrating video and audio respectively pertaining to different kinds;
a USB network phone integrated circuit for processing a digital signal transmitted to the USB hub integrated circuit through a cable, and decoding the digital signal into an audio signal that can be heard by a human ear;
an audio amplifier circuit for amplifying a power of the audio signal; and
an echo killer for killing a howling sound generated by a feedback audio signal; and
an adjustable camera, which comprises:
a USB video sensor integrated circuit, which is composed of an upper video sensing unit and a lower video dedicated integrated circuit of a processing circuit structure, processes various external signals corresponding to light with various colors and brightnesses, analyzes the external signals into a data packet satisfying a USB transmission specification, and transfers the data packet to the USB hub integrated circuit.

2. The webcam according to claim 1, wherein the USB hub integrated circuit is connected to the cable having a USB plug.

3. The webcam according to claim 1, wherein the USB network phone integrated circuit is connected to a key set disposed on an exterior of the webcam.

4. The webcam according to claim 1, wherein the audio amplifier circuit is connected to a speaker disposed on an exterior of the webcam.

5. The webcam according to claim 1, wherein the audio amplifier circuit comprises an earphone jack, which is disposed on an exterior of the webcam, and may be connected to an external earphone.

6. The webcam according to claim 1, wherein the echo killer is connected to a microphone disposed on an exterior of the webcam.

7. The webcam according to claim 1, wherein the echo killer comprises a microphone jack, which is disposed on an exterior of the webcam and may be connected to an external microphone.

8. The webcam according to claim 1, wherein the video sensing unit is connected to an optical lens disposed on an exterior of the webcam.

9. The webcam according to claim 1, wherein the adjustable camera has opposite knobs pivotally mounted on two sides of the adjustable camera, and two extension arms having slots are formed on two sides of the network phone.

10. The webcam according to claim 3, wherein the key set comprises an answer button, a hang-up button, a volume-up control, a volume-down control and a switch control.
